(19) United States
(12) Patent Application Publication
(10) Pub. No.: US 2008/0086314 A1
(43) Pub. Date: Apr. 10, 2008

(54) Entity-Linking System to Report the Death of a Person

(76) Inventor: Yvonne Fitzpatrick, Streamwood, IL (US)

Correspondence Address: GREENBERG & LIEBERMAN, LLC, 2141 WISCONSIN AVE, N.W., SUITE C-2, WASHINGTON, DC, 20007, US

(21) Appl. No.: 11/306,328

(22) Filed: Dec. 22, 2005

(51) Int. Cl. G06Q 99/00; G06F 17/30; G06F 17/40; G06F 19/00

(52) U.S. Cl. 705/1

(57) ABSTRACT

A computer network system, which links one or more life insurances, a selected funeral home, hospitals and the Social Security Administration to notify all concerned entities when a death has occurred. A death notice is posted and automatically sent to a selected funeral home director who then notifies the appropriate life insurance company (ies), Social Security Administration, pension providers and other concerned entities. In this fashion, the family does not have to undertake such a task themselves, and the related entities can all access the database where the pertinent information is gathered for statistical and research purposes.

### FIELD OF THE INVENTION

This invention relates to a network system that links various entities such as life insurance companies, the Social Security Administration and banks to notify them when a death occurs.

### BACKGROUND OF THE INVENTION

There is a need for a central repository database that connects funeral home directors, patient care facilities and insurance or financial institutions on a national level. Presently, there is no governing body or national network to even connect funeral home directors; this would be useful and necessary to account for the vital statistics of the country. Additionally, these statistics are used for health policy, funding and research. Nor is there any electronic submission of death certificates to a national database or the like, as death certificates are still recorded manually.

In the past, notification that a death has occurred was accomplished by sending one or more copies of the death certificate to all interested parties, such as insurance companies, funeral homes, patient care facilities and the Social Security Administration. This death certificate was commonly issued by the local entity charged with the responsibility for doing so such as the Office of Public Record in the jurisdiction where the death occurred. The heirs or the administrator of the descendant's estate would then send one or more copies of this certificate to the entities. Needless to say, this is a time consuming process that can result in errors and delays at a time when prompt and accurate action is required.

Systems that retrieve and/or disseminate information are disclosed in prior art. For example, U.S. Pat. No. 4,915,611 to Doyle, Jr. et al. discloses a computerized insurance claim processing system. U.S. Pat. No. 5,235,507 to Sackler et al. a data processing system for health insurance management is disclosed which verifies the insurance status of the claimant. These two patents are unlike the present invention in that they relate particularly to health insurance companies and do not link disparate entities together to inform them of a death of a client. U.S. Pat. No. 5,241,466 to Perry et al. discloses a central depository for secure storage and rapid retrieval of documents such as wills. While it is useful for retrieving such pertinent documents, it makes no mention of being able to notify various entities such as banks and life insurance companies of a death. U.S. Pat. No. 5,651,117 to Arbuckle discloses a system for disseminating obituaries by a depository that monitors reports of death and selectively transmits them to the appropriate agencies. While the aforementioned patent seems particularly relevant, the present invention is an improvement upon the existing system by allowing the various entities to access the databases where the information is kept, and contribute and/or modify said information if necessary.

In a PR Newswire article dated Sep. 14, 1998, entitled, “New York State Department of Health and Sybase Develop Web Application to Managne Vital Statistics Information,” a system of electronic collaboration between funeral directors, hospital workers, and coroners. Unlike the present invention, it is not a national database as it is limited to one state; nor does it make any reference to the automatic issuing of benefits from processed life insurance claims; nor does it mention the possibility of the various entities being able to modify and contribute specific information to the network. Additionally, it does not aim to include other relevant entities, specifically the Social Security Administration, banks, and life insurance companies, to automatically process the required information to terminate or transfer the deceased's benefits.

Currently, under the present system, the death certificates are written by hand. There is no standardization of the process, nor are there codes to explain the reason for death, which would simplify the process.

### SUMMARY OF THE INVENTION

The present invention is a method for having a database that is dynamic instead of static; meaning that the concerned entities are able to access and modify the information stored on the database.

In the present invention, a computer network system links life insurances, funeral homes, patient care facilities and the Social Security Administration to notify all entities when a death has occurred. A death notice is posted and automatically sent to a selected funeral home director who then communicates with the appropriate life insurance company, the Social Security Administration and other concerned entities all as will be detailed in the specification that follows hereafter. The present invention is unique in that it would enable a national database and/or repository for death certificates. It would also allow the various entities concerned when a person passes away to not only be notified of the death, but also enable the users to access the information on the server and modify/contribute to the case if needed. For example, a user at an insurance company can enter the information pertinent to the deceased's life insurance policy, while a user at a bank or the Social Security Administration will be responsible for recording different but equally relevant information.

The present invention relates to a computer network system which links one or more life insurances, a selected funeral home, patient care facilities and the Social Security Administration to notify all concerned entities when a death has occurred. A death notice is posted and automatically sent to a selected funeral home director who then notifies the appropriate life insurance company, Social Security Administration, pension providers and other concerned entities. Posting of the death notice will be imported via a scan able automatic entry able input into the secured computer network by authorized individuals. It is the primary object of the present invention to provide for an improved computer-based system, which links and notifies concerned entities when a death occurs.

Another object is to provide for such a system when a death notice is first posted and scanned, simultaneously creating an e-copy imported as part of the record then automatically sent by a selected funeral director to one or more insurance companies, the Social Security Administration and other concerned entities.

Additionally the data contained in the repository may be requested and accessed on demand by members of the network for research and statistical purposes. Each subscriber in the network is connected via a system that processes data in and out of the repository securely. In the relevant art, each subscriber operates independently from the other. This results in a redesigned approach to the dissemination of information upon a person's death, where before the subscribers could not get past the infrastructure of their own organization. The secure network links subscribers of each city, county and state region of the entire United States.

The importance of this is that there will now be a centralized and traceable approach for the essential component of public health. Statistics based on deaths registered in the United States are an important source of data in determining mortality rates, which are in turn used by the insurance industry. This same information affects health policies, social services and research funding. The systems that are currently in place are based on outdated practices and procedures, which call into question the quality of the data and the lack of real-time linkage capabilities.

It is a final object of the present invention to allow the various entities within the linking network to access and manage the database and make any necessary additions or adjustments to the information about the deceased. The users of the present invention are: Patient Care Facilities, Funeral Homes, Mortuaries, State and County Medical Examiner's, Life Insurance Companies, Banking Institutions, Federal Government.

These and other objects and advantages of the present invention will become apparent to readers from a consideration of the ensuing description and the accompanying drawings.

### BRIEF DESCRIPTION OF THE DRAWINGS

FIG. 1 is a flow diagram indicating some of the steps and entities currently involved in the death of a loved one for the purposes of comparison.

FIG. 2 is a flow diagram indicating some of the steps and entities involved in the notification process of the present invention.

FIG. 3 is a schematic diagram indicating some of the hardware used to transmit the death notification notice sent to the entities in FIG. 1.

### DETAILED DESCRIPTION OF THE PREFERRED EMBODIMENT

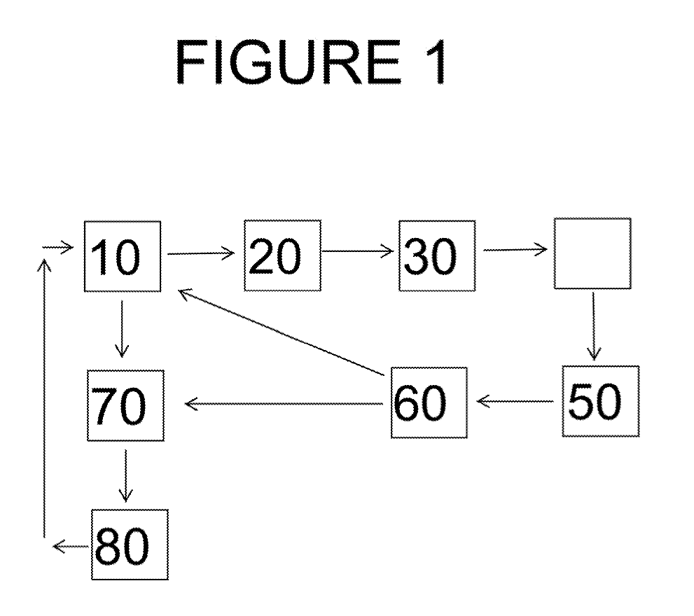

FIG. 1 is a flow diagram indicating the typical current process steps and entities involved in the notification process when a death occurs. A loved one of a family 10 becomes ill and is sent to a patient care facility 20. After death, the body is picked up by a designated mortuary establishment 30 and taken to a funeral home 50. The funeral home 50 receives a death certificate 60 from the patient care facility 20 and provides for the filing and distribution of the copies to the family 10 of the deceased. The family makes the necessary arrangements of a memorial service and burial arrangements with the funeral home 50 or funeral home director including the payment of fees for these services. The family members 10 would contact any insurance companies 70, and provide them with the name, date of death, date of birth, policy number(s), and if available, the Social Security number of the deceased. If any Social Security benefits are to be paid (i.e., funeral expenses) or are to be changed or cease being paid (like monthly benefits) notification would also be made to the Social Security Administration (SSA). Appropriate document and death certificate sent for verification purposes would also be sent to the SSA. Any pension supplier may also be notified in the same step with instruction to stop or adjust the decedent's pension benefits as necessary. Typically, a notified life insurance company 70 would initiate a claim and send the beneficiary a compensation check 80 in accordance with their contract provisions, which would then be received by the beneficiaries 10 in about six to eight weeks after submission. Clearly, this type of process to notify concerned entities about the death of a person and to receive or cease any pension or other benefits is a time consuming process with the possibility of delays and errors ever present. It is also difficult for a grieving family to have to take these matters into their own hands.

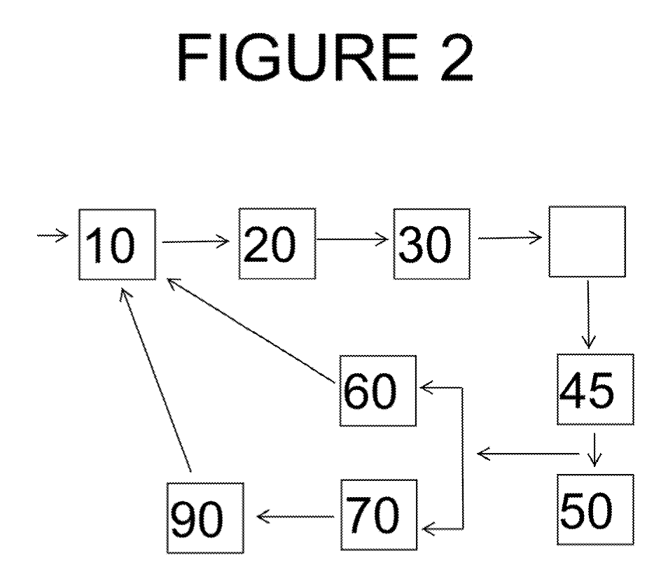

FIG. 2 is a flow diagram indicating some of the steps and entities involved in the notification process when death occurs practicing the present invention referred to as Lifenet. As before, a member of a family 10 becomes ill and is sent to a patient care facility 20. Should the loved one pass away, the body is sent to a selected funeral home 50. Here, a death certificate 60 is received from the patient care facility 20 and the funeral home director 45 or funeral home 50 provides for its filing and distribution to concerned entities—for example life insurance company 70 and bank 90—with copies for the family/beneficiaries 10. As before, the family 10 arranges for a memorial service and burial arrangements with the funeral home director 45, including payment arrangements. The funeral home director 45 enters vital statistics about the deceased into the computer network system termed Lifenet along with beneficiary-supplied bank information, insurance company information, SSA information and any other pertinent information including pension information:

Patient Care Facility

Address of Patient Care Facility

IP Address on File

Name

Age

Address, City, State and Zip

SSN

Driver's License Number (if available)

Last known phone number (if available)

Veteran Indicator (Y/N)

Time of Death

Cause of Death 1

Secondary Cause of Death

Chronic Illness(s) Indicator Y/N

Illness 1

Illness 2

Illness 3

Location of Death

Physician Name

Physicians ID

Autopsy preformed Indicator Y/N

Expansion section

Name of Next of Kin or Responsible Party

Address, City, State, Zip

Transmission Indicator

Transmission Processed Date Stamp

Transmission Time Stamp

Name of Funeral Home

IP Address on File

Funeral Director ID

Address of Funeral Home, City State and Zip

Date Certificate of Death received/scanned

eCopy of Death Certificate

Date Body Transferred

Date Body Received (In case of out of town transport)

Type of services performed Indicator: C—Cremation, E—Embalmed

Date of Memorial

Cost of service

Transmission Indicator

Transmission Processed Date Stamp

Transmission Time Stamp

Insurance Indicator (Y/N)

Multiple Policy Indicator (Y/N)

Policy Number

Life Insurance Company Name 1

IP Address on File

Policy Number 2

Life Insurance Company Name 2

IP Address on File

Policy Number 3

Life Insurance Company Name 3

IP Address on File

Life Insurance Company address 1

Life Insurance Company address 2

Life Insurance Company address 3

Survivor's Benefits approved indicator (Y/N)

Transmission Indicator

Transmission Processed Date Stamp

Transmission Time Stamp

Pension Account Number

Pension Company Name

IP Address on File

Transmission Indicator

Transmission Processed Date Stamp

Transmission Time Stamp

Receiving Bank Information

IP Address on File

Routing Information

Account Information

Account name information

Transmission Indicator

Transaction processed date stamp

Transaction Time stamp

The entities themselves have the ability to modify, update and or correct the data so as to provide a more accurate and complete picture available for all of the entities. Thus, in this regard the present invention has a dynamic database because concerned entities can modify the data.

This submitted information is then transmitted to these pre-selected entities, and results in the automatic processing by the insurance company 70 or the bank 90, for example, without the family needing to take the initiative to do so. This initiates a claim process and then provides an E-Commerce based transaction set to transmit electronically through federal accepted standards and guidelines for banking transactions and placed in a deposit account for the deceased's family/beneficiary 10. Typically, the compensation from a life insurance company is deposited to the credit of the beneficiary 10 about two to three weeks after notification. The additional feature of the present invention is that the information is stored on a database that can be accessed by the various entities.

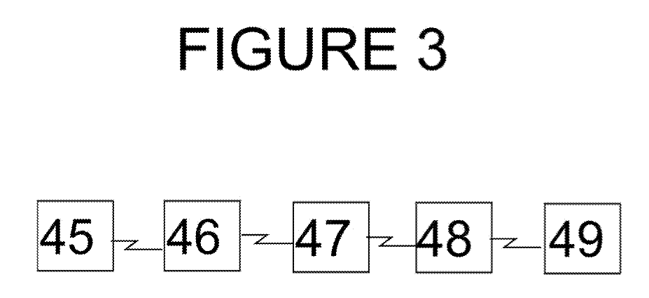

FIG. 3 is a schematic diagram indicating some of the hardware used to transmit the death notification notice sent to the entities in FIG. 2. All hardware shown is conventional and state of the art and digital signals are transmitted to the entities indicated. The funeral home director 45 has a comprehensive set of computer programs loaded into his or her personal computer 47, or via a web-based server, which provides a menu approach for entry of appropriate relevant data about the decedent. The programs can be modified as needed and would include the current conventional technology available. Such programs would be designed to run in a multi-platform environment. Data from the PC would be transmitted digitally via a modem 46 or via a web-based transaction to a network server, followed by transmission of required data components 47, which then contacts the mainframe computers 48 and 49 of the entities to be contacted, such as the Insurance Company, the Bank, the SSA, government agencies concerned with vital statistics, and any other concerned entities, like pension plan providers. The transmitted data will be sent through a secured encrypted line and each contacted entity will have the necessary mainframe computer hardware and software to permit the decoding of the transmitted information. The death certificate travels along with the data and is also housed in the repository. This way when an entity desires to see statistics, they can also see a copy of the document. The document can be scanned and imported to the record at the funeral home by the director 45. This will also provide for any error checking which may be needed later, or verification by an entity.

Essentially, the present invention is facilitating the process of alerting concerned individuals and companies about the death of a family member. It takes the responsibility of tackling frustrating paperwork and long phone calls out of the hands of the grieving family and places it into the funeral director's hands. It also makes national research concerning vital statistics more feasible and accessible.

Having illustrated the present invention, it should be understood that various adjustments and versions might be implemented without venturing away from the essence of the present invention. The present invention is not limited to the embodiments described above, and should be interpreted as any and all embodiments within the scope of the following claims.

What is claimed is:

1. A computer network system informing concerned entities that a person has died, comprising the steps of:
a patient care facility transmitting a death notice to a funeral home;
a funeral home receiving the death notice from the patient care facility;
a funeral home storing information from the death notice in the computer network;
concerned entities linking via said computer network to the funeral home;
concerned entities accessing and modifying information stored on said computer network.

2. The computer network system of claim 1 further comprising a database to store vital statistics information.

3. The computer network system of claim 1 further comprising a database permitting access by said concerned entities to said database.

4. The computer network system of claim 1, wherein said concerned entities linked to said computer network and said funeral home also has a government entity charged with maintaining vital statistics within a community.

5. The computer network system of claim 1, wherein said patient care facility notification center is linked to said funeral home by a digital transmitting medium and hardware capable of transmitting a digital signal from the patient-care facility notification center, which can be received by said funeral home.

6. The computer network system of claim 1, further comprising a pension plan administration office linked to said funeral home through said computer network to receive and transmit digital signals.

7. A computer network-based method to transmit death notices to concerned entities comprising the steps of:
providing a death notice from a patient care facility to a funeral home;
transmitting the death notice to said concerned entities linked to said funeral home, said concerned entities chosen from the group of insurance companies, banks and the Social Security Administration;
concerned entities receiving the death notice from the funeral home;
concerned entities retaining data transmitted; and
concerned entities acting on the data to provide any compensation due to beneficiaries of the person covered by the death notice.

8. The computer network system of claim 7 further comprising creating an e-copy of the death certificate.

9. The computer network system of claim 8 further comprising importing as part of the record the e-copy of the death certificate.

10. The computer network system of claim 9 further comprising automatically sending by a selected funeral director the e-copy of the death certificate to one or more insurance companies, the Social Security Administration and other concerned entities.
